(19) United States
(12) Patent Application Publication
(10) Pub. No.: US 2014/0075720 A1
(43) Pub. Date: Mar. 20, 2014

(54) HINGE

(71) Applicants: Bartholomew Jeremy Caffin, North Manly (AU); Filip Tejszerski, Mosman (AU)

(72) Inventors: Bartholomew Jeremy Caffin, North Manly (AU); Filip Tejszerski, Mosman (AU)

(73) Assignee: D & D Group PTY Ltd, Frenchs Forest, NSW (AU)

(21) Appl. No.: 13/983,658

(22) PCT Filed: Jan. 30, 2012
(86) PCT No.: PCT/AU2012/000068

§ 371 Date: Dec. 2, 2013

Related U.S. Application Data
(60) Provisional application No. 61/439,768, filed on Feb. 4, 2011.

(51) Int. Cl. E05F 1/12

(52) U.S. Cl. CPC E05F 1/1207
USPC 16/298

(57) ABSTRACT

A hinged and a mechanism for the hinge is described herein.

### FIELD OF THE INVENTION

The present invention relates to a hinge, and in particular to a hinge that is biased into either an open or a closed position.

### BACKGROUND OF THE INVENTION

Swinging barriers that must close automatically—such as a gate in a pool, playground or preschool fence—may be supported by a hinge that exerts a closing force on the gate. The closing force is chosen to close but not slam the gate, the latter of which may cause the gate to bounce and subsequently return with insufficient speed to operate an associated latch for fastening the gate.

In some situations, however, the barrier must remain open unless fastened closed. An opening force exerted by a hinge that may support the barrier must be sufficient to swing to gate open but not slam the barrier into adjacent structures such as a fence or wall, an event that may cause damage.

### SUMMARY OF THE INVENTION

According to a first aspect of the invention, there is provided a hinge comprising first and second hinge parts;

a coupling connecting the first and second hinge parts wherein when so connected, the first and second hinge parts are rotatable relative to each other about an axis;

a biasing member operative to impart a biasing force through the coupling to restrain relative rotation of the hinge parts;

the coupling comprising a first coupling portion that is movable to change the biasing force of the biasing member, wherein the hinge further comprises a stop arrangement to limit the adjustment movement to thereby restrict change to the biasing force.

In an embodiment, during the movement of the first coupling portion to change the biasing force the first coupling portion rotates relative the at least one hinge part about the axis. The biasing member may be in the form of a resilient member and the movement twists the resilient member to vary the biasing force. The resilient member may comprise a torsion spring.

In an embodiment, the coupling further comprises a second coupling portion, wherein the movement of the first coupling potion to change the biasing force causes at least one of the first and second coupling portions to move relative to the other of the first and second coupling portions. The stop arrangement may comprise first and second stop members disposed on respective ones of the first and second coupling portions, the stop members being operative to move into engagement under relative movement of the coupling portions and wherein, when so engaged, to prevent further relative movement of the coupling portions in at least one direction to thereby restrict the adjustment movement. The biasing member may be restrained relative to the first and second coupling portions, and the first and second coupling portions are connected to respective ones of the first and second hinge parts in a manner that prevents relative rotation therebetween. The first and second coupling portions define a space in which the biasing member is located. At least one of the stop members may project into the space. The first and second coupling portions may be interchangeable. Each of the first and second coupling portions may taper in a series of steps towards a respective outwardly facing end. The first and second portions may have a notch. One of the first and second portions may comprise a tooth arranged to be receivable by the notch. The first and second portions may be configured such that when brought together a cartridge is formed that houses the resilient member.

In an embodiment, the first hinge part includes a first engagement surface and the first coupling portion includes a complementary shaped first engagement surface, the hinge being able to be configured so that the first engagement surfaces are engagable to prevent relative rotation between the first coupling portion and the first hinge part in at least one direction. The second hinge part may include a second engagement surface and the first coupling portion includes a complementary shaped second engagement surface, the hinge being able to be configured so that either the first or the second engagement surfaces are engaged to prevent relative rotation of the first coupling portion and a respective one of the first and second hinge parts in at least one direction. The engagement surfaces may be disengagable and are required to disengage to enable the first coupling portion to undergo the movement to change the biasing force of the biasing member. The engagement surfaces may be disengaged by moving the first coupling portion inwards along the axis. The inward movement of the first coupling portion may be resisted by the biasing member which biases the first coupling portion outwards along the axis.

In an embodiment, the first and second hinge parts each have a respective leaf.

In an embodiment, the first coupling portion engages the first hinge portion part in a first orientation and can be disengaged from the first hinge part and rotated to twist the biasing member and then brought back into engagement with the first hinge part in a second orientation.

In an embodiment, the biasing member has a leg and the leg is disposed between two lugs projecting from the first coupling portion.

In an embodiment, the hinge has a first configuration in which the stop arrangement is inoperable and a second configuration in which the stop assembly is operable. The stop arrangement may be operable when the first coupling portion is moved inward along the axis. The stop arrangement may be inoperable when the first coupling portion engages with the first hinge part such that relative rotation between the first coupling portion and the first hinge part is prevented.

According to a second aspect of the invention there is provided a coupling assembly for a hinge having an axis and opposite ends spaced along the axis, the coupling assembly comprising a biasing member, and first and second coupling portions disposed on the opposite ends of the biasing member, the coupling assembly being arranged to engage with first and second hinge parts and, when so engaged, the first and second hinge parts are rotatable relative to each other about the central axis and the biasing member is operative to impart a biasing force through the coupling portions to restrain relative rotation of the hinge parts.

In an embodiment, the biasing force of the biasing member can be varied by relative rotation of the coupling portions and the assembly further comprising a stop arrangement comprising first and second stop members disposed on respective ones of the first and second coupling portions, the stop members being operative to move into engagement under relative movement of the coupling portions and wherein, when so engaged, to prevent further relative movement of the coupling portions in at least one direction to thereby restrict change to the biasing force. The stop assembly may have a first configuration in which the stop arrangement is inoperable and a second configuration wherein the stop arrangement is operable. In the second configuration the first and second portions may be brought together. In the first configuration the first and second portions are spaced apart.

In an embodiment, the coupling assembly is arranged to be manipulated by a machine assembling the hinge.

In an embodiment, the first and second coupling portions define a space in which the biasing member is located.

In an embodiment, the first coupling portion includes a first engagement surface arranged to be engagable with a complementary shaped first engagement surface in first hinge part to prevent relative rotation between the first coupling portion and the first hinge part in at least one direction. The first coupling portion may further include a second engagement surface arranged to be engagable with a complementary shaped second engagement surface in the second hinge part so that the coupling assembly can be arranged with either the first or the second engagement surfaces engaged to prevent relative rotation of the first coupling portion and a respective one of the first and second hinge parts in at least one direction.

In a third aspect of the invention there is provided a hinge incorporating first and second hinge parts of a coupling assembly according to any from described above with respect to the second aspect.

### BRIEF DESCRIPTION OF THE DRAWINGS

Embodiments of the present invention will now be described with reference with the accompanying figures in which:

FIG. 1 presents a perspective front view of one embodiment of a hinge;

FIG. 2 presents an exploded perspective front view of most of the hinge of FIG. 1;

FIG. 3 shows a perspective view of a coupling assembly of the hinge of FIG. 1 in a collapsed configuration to form a cartridge;

FIG. 4 shows a top view of a coupling portion of the coupling assembly of FIG. 3;

FIG. 5 shows a bottom view of the coupling portion of FIG. 4;

FIGS. 6 and 7 show alternative side views of the coupling portion of FIG. 4; and

FIG. 8 shows a bottom view of a part of the hinge of FIG. 1.

### DETAILED DESCRIPTION OF THE PREFERRED EMBODIMENTS

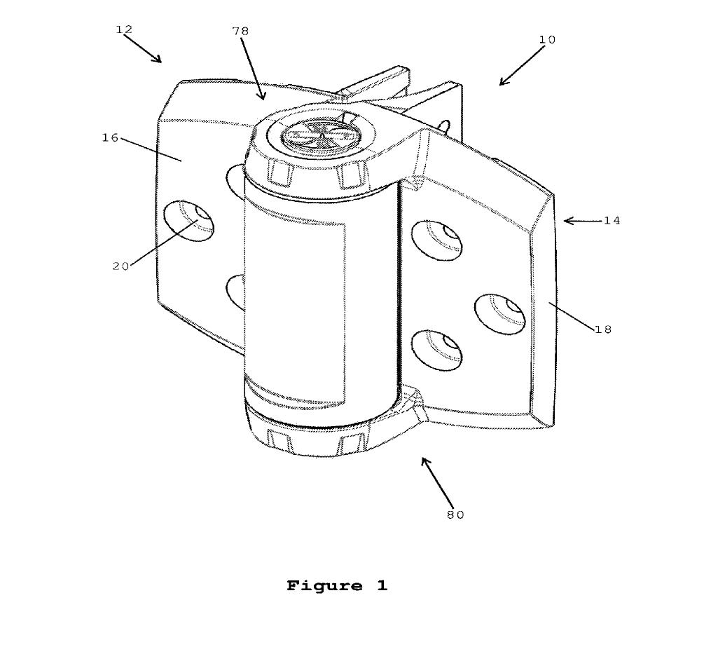

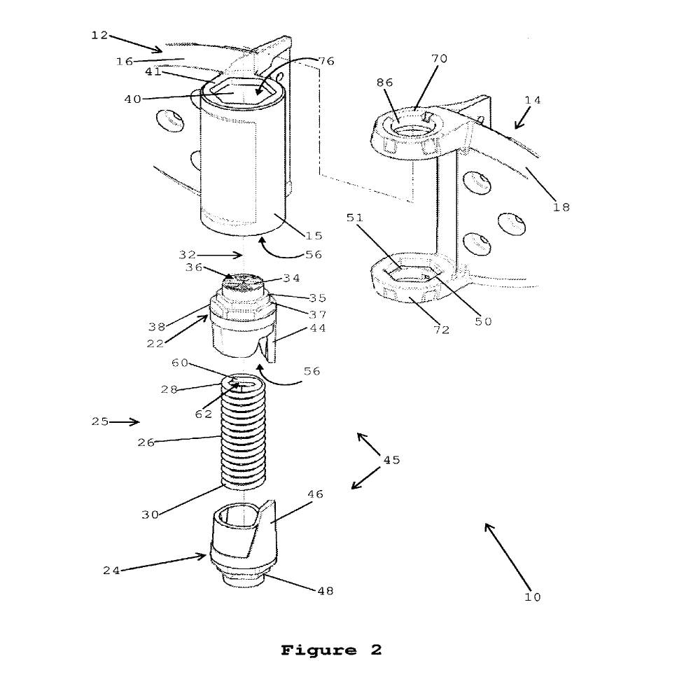

FIG. 1 presents a perspective front view of one embodiment of a hinge, the hinge being generally indicated by the numeral 10. FIG. 2 presents an exploded perspective front view of most of the hinge of FIG. 1. A swinging barrier, such as a gate, that may be supported by the hinge 10 may be biased to either one of open and closed positions by the hinge 10. The hinge 10 has two hinge parts generally indicated by numeral 12 and 14, which will be referred to as the left part 12 and the right part 14. The relative position of the parts may be reversed by, for example, inverting the hinge 10 and so the use of “left” and “right”, “top” and “bottom” is for convenience only. Each of parts 12 and 14 has a respective hinge leaf 16 and 18. The leaves 16 and 18 are configured to be fastened to respective structures, such as a gate and a post adjacent the gate. Other possible structures include a door and a door frame. In this embodiment, each leaf has apertures 20 through which mechanical fasteners, such as screws, can pass and penetrate the respective structure. Other forms of attachment, such as by adhesive, may be alternatively or additionally used.

As best understood with reference to FIG. 2, the hinge 10 has two spaced apart pieces, each generally indicated by the numerals 22 and 24 respectively. For convenience, piece 22 will be referred to as the top piece (or first coupling portion) and piece 24 will be referred to as the bottom piece (or second coupling portion). The top piece 22 engages the left part 12 and the bottom piece 24 engages the right part 14. The top and bottom pieces are identical in the present embodiment and consequently interchangeable but this is not so in all embodiments. The left part 12 comprises an attached cylindrical housing 15 in which the top and bottom pieces are at least in part housed. The top piece has an engaging structure in the form of a hexagonal cylindrical portion 38 presenting an engagement surface that mates with a corresponding engaging structure 41 presenting a complementary engagement surface defining a hexagonally shaped aperture 40, of the housing 15 and centred on an axis generally indicated by the numeral 32. As the structure is hexagonally shaped it can have 6 orientations with respect to the housing 15.

The hollow housing 15 is disposed between two spaced apart appendages 70, 72 of the right part 14, disposed along the axis 32 and at opposite ends of the hinge. A passageway 74 extends between opening 56 and opening 76 openings. For convenience, the appendages will be referred to top 70 and bottom 72 appendages. The pieces (or coupling portions) are disposed adjacent respective ends 80, 78 of the housing 15.

The hinge has a biasing member 26 disposed within the housing 15 and in a space intermediate the top 22 and bottom 24 pieces. In this embodiment, the biasing member is resilient and is a type of torsion spring—a helical torsion spring—but any other suitable biasing means, such as a torsion bar, torsion fibre, a piece of elastomer or rubber material, magnetic elements etc. may be used. The spring has opposite top 28 and bottom 30 ends. The biasing member 26 linearly biases the top 22 and bottom 24 pieces to respective engagement positions. The spring is generally twisted around the axis 32. The spring exerts a force opposing the twist. The top end 28 of the spring engages the inside of the top pieces 22 and the bottom end 30 of the spring engages the inside of the bottom piece 24, such that a twisting force exerted by the spring 26 is transferred through the pieces to the parts. Consequently, the spring 26 exerts a force through the pieces 22, 24 to rotationally bias one of the parts with respect to the other. This in turn biases the swinging barrier, such as a gate, to either one of open and closed positions.

The spring 26 and the spaced apart pieces 22, 24 form a coupling, generally indicated by numeral 25, that connects the hinge parts 12, 14. The parts may rotate around the axis 32 relative to each other when so coupled.

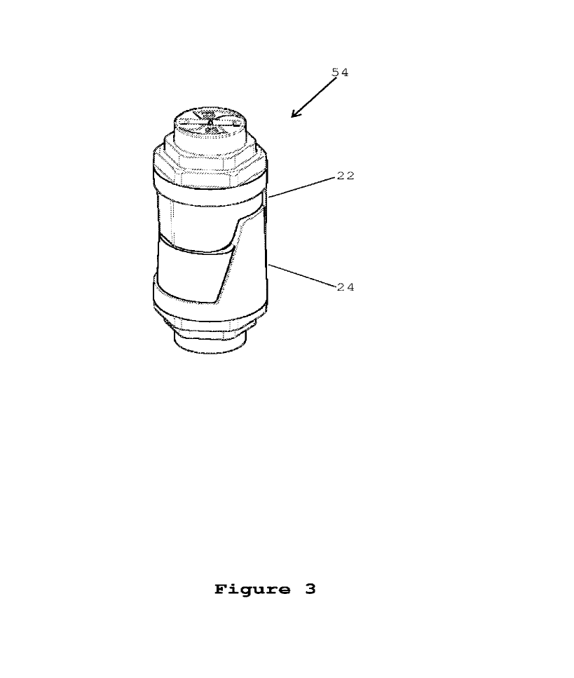

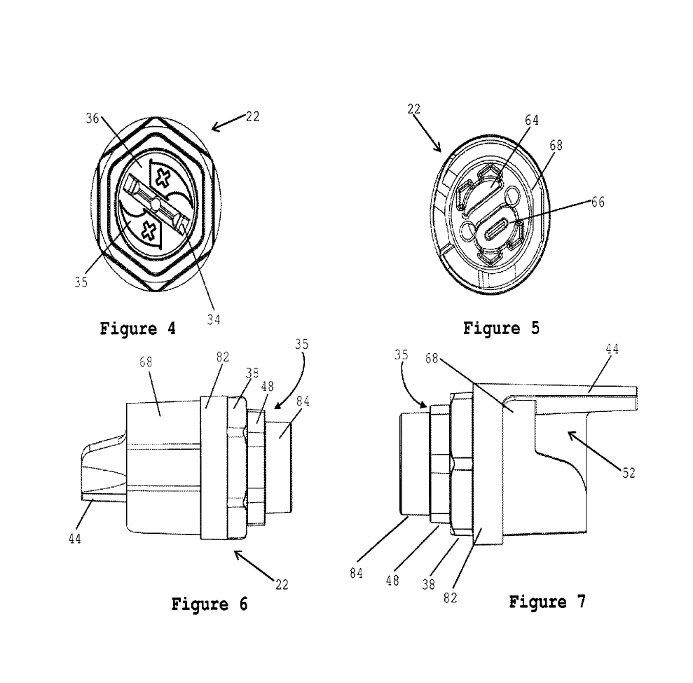

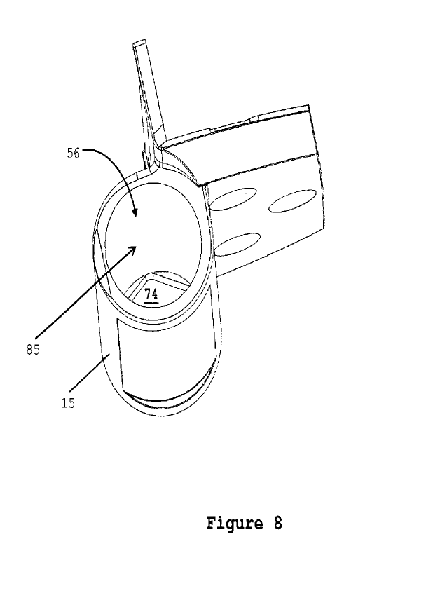

For adjustment of the twisting force exerted by the spring, the top piece (and in some but not all embodiments also the bottom piece) can be disengaged from its respective part by translating the piece against the linear bias of the spring 26. To facilitate this, the top piece (first coupling portion) of the present embodiment is configured to engage a tool. FIG. 4 shows a plan view of the top piece 22 of the hinge of FIG. 1. A flat head screw driver may be inserted into a slot 34 formed in an outward facing surface 36 presented by the top piece 22 and the screw driver subsequently pressed down to translated the piece. In other embodiments the outward facing surface may be adapted to receive some other drive tool such as a hex or Phillips screwdriver. In alternative embodiments, a hand operable actuator, such as a knob, may extend from the top piece to facilitate hand rather than tool assisted disengagement and rotation of the piece.

Subsequent to the top piece 22 being disengaged from the left part 12, the top piece may be rotated relative to the bottom piece and the left and right parts to either increase or decrease the twisting of the spring and thus the twisting force exerted by it. Embossed on the piece are indicia 35 indicating the direction the piece should be rotated to increase the twist of the spring. Once the desired degree of spring twist is achieved, the downward pressure on the driver may be withdrawn from the top piece to allow the top piece to reengage the left part 12 in a new orientation. In this way the closing force, or bias, exerted by the hinge on a swinging barrier, such as a gate, it may support may be adjusted as required by circumstance.

The bottom piece 24 has another hexagonal cylindrical portion 48 presenting an engagement surface that mates with a complementary shaped engagement surface defining a hexagonally shaped aperture 50 formed in the bottom portion 72 of the right part 14. Cylindrical portion 48 is centred on the central axis 32. The diameter of aperture 50 is less than the diameter of aperture 40. In this but not necessarily all embodiments, the hinge 10 can also be adjusted by depressing the bottom piece, rotating it to a new relative position, and then releasing it. In alternative embodiments, the bottom piece 24 may be fixed to the right hand part, by a pin for example.

Projecting into a space between the end pieces 22, 24 are stop members 44, 46 of a stop assembly generally indicated by numeral 45. The members 44 and 46 are each attached to a respective piece (coupling portion), and in this case are integral to the piece but need not be in other embodiments. FIGS. 6 and 7 show alternative side views of the top piece of FIG. 1 (the bottom piece may be identical). The two stop members are each in the form of a tooth 44, 46. The pieces 22, 24 are disposed such when one of them is disengaged and rotated relative to the other, the members 44, 46 can be brought together and when so brought together prevent further twisting of the resilient member. Thus, the spring cannot be overly twisted by a user adjusting the hinge. Excessive twisting of the spring may damage it and other components of the hinge. Failure of the hinge 10 by excessive twisting may result in the spring 26 being released at great speed which may cause damage or perhaps injury to an eye. When both pieces are released and returned to engagement positions with their respective part, however, the members do not extend past each other and thus do not interfere during normal operation of the hinge.

Each piece 22, 24 has a respective notch generally indicated by the numeral 52. The notch has a complementary shape to the tooth so that the parts can be brought together in which case each notch receives the tooth of the other member. FIG. 3 shows a perspective view of top 22 and bottom 24 pieces of the hinge 10 of FIG. 1 brought together to form a cartridge, generally indicated by the numeral 54. The cartridge conveniently houses the resilient member. During assembly of the hinge, the cartridge can be loaded into the cylindrical housing 15 via a bottom opening 56 of the housing which has a greater diameter than that of the cartridge and so also that of each of the pieces. The left 12 and right 14 hand parts can then be brought together. The pieces can then be allowed to be moved by the spring 26 into engagement positions with their respective parts to complete assembly of the hinge. The cartridge is suitable for its loading into the housing 15 by a machine, which may be much faster and safer than manual loading.

FIG. 5 shows a bottom view of the piece 22 of FIG. 4, which is the same as the bottom view of piece 24 because the top and bottom pieces are identical in the present embodiment. The top end 28 of the spring 26 is received by the top piece 22 within a collar 68, and the bottom end 30 of the spring is similarly received by the bottom piece 24. This restrains the biasing member relative to the pieces (coupling portions). Each end of the spring 26 has a leg 60. The leg 60 crosses an end opening 62 of the spring. When the ends of the spring are received by their respective pieces, the legs are each disposed between two lugs 64 and 66, lug 66 being bigger than lug 64. The lesser lug 68 makes space for the greater lug 66. The lugs project from their respective piece and are received within the spring. The majority of the end of the spring is thus located in an annular space between the collar 68 and the lugs to precisely position the spring. The lugs 64 and 66 are asymmetrically placed on either side of a diameter of the piece. The greater lug 66 takes a majority of the spring twisting force. The asymmetric lug configuration is a very strong engagement point for the spring and the greater lug 66 is able to support relatively great spring twisting forces. Thus a hinge having an asymmetric lug configuration is stronger than a hinge having, for example, lugs of the same or similar size.

The pieces each have two outwardly facing bearing surfaces 82 and 84, one having a greater diameter than the other. The greater bearing surfaces 82 bears against an inwardly facing bearing surface 85 of the housing 15 located at the inside lip of the opening 56. The lesser bearing surface 84 bears against an inwardly facing bearing surface 86 of the top portion 70. The part 22 also has a flat surface 35 which is seated on a corresponding flat surface of the respective portion. The part 24 is arranged to be received into seat 51.

In the present embodiment, each of the pieces 22, 24 taper down in a series of steps towards their end that is received by respective portions 70, 72. The bearing surface 84 has the least diameter. The bearing surface 84 is followed by the hexagonal cylindrical portion 48 of greater diameter, the other hexagonal cylindrical portion 38 having a greater diameter than that which precedes it, and then the other bearing surface 82 which has the greatest diameter. This arrangement facilitates the interchangeable nature of the pieces 22, 24.

The left and right parts, and the top and bottom pieces may be fabricated of a glass reinforced plastic such as nylon, for example, using an injection moulding process, although any suitable materials and processes may be used.

It will be understood to persons skilled in the art of the invention that many modifications may be made without departing from the spirit and scope of the invention. For example, if coarser of finer adjustments are desirable then other polygons may replace the hexagonals. The engaging parts of other embodiments have other shapes, such as flower shapes. A wide variety of engaging shapes are generally suitable.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A hinge comprising first and second hinge parts;
a coupling connecting the first and second hinge parts wherein when so connected, the first and second hinge parts are rotatable relative to each other about an axis;
a biasing member operative to impart a biasing force through the coupling to restrain relative rotation of the hinge parts;
the coupling comprising a first coupling portion that is movable to change the biasing force of the biasing member, wherein the hinge further comprises a stop arrangement to limit the adjustment movement to thereby restrict change to the biasing force.

2. A hinge according to claim 1, wherein during the movement of the first coupling portion to change the biasing force the first coupling portion rotates relative the at least one hinge part about the axis.

3. A hinge according to claim 2, wherein the biasing member is in the form of a resilient member and the movement twists the resilient member to vary the biasing force.

4. A hinge according to claim 3 wherein the resilient member comprises a torsion spring.

5. A hinge according to any one of claims 1 to 4, wherein the coupling further comprises a second coupling portion, wherein the movement of the first coupling potion to change the biasing force causes at least one of the first and second coupling portions to move relative to the other of the first and second coupling portions.

6. A hinge according to claim 5, wherein the stop arrangement comprises first and second stop members disposed on respective ones of the first and second coupling portions, the stop members being operative to move into engagement under relative movement of the coupling portions and wherein, when so engaged, to prevent further relative movement of the coupling portions in at least one direction to thereby restrict the adjustment movement.

7. A hinge according to either claim 5 or 6, wherein the biasing member is restrained relative to the first and second coupling portions, and the first and second coupling portions are connected to respective ones of the first and second hinge parts in a manner that prevents relative rotation therebetween.

8. A hinge according to any one of the claims 6 to 7, wherein the first and second coupling portions define a space in which the biasing member is located.

9. A hinge according to claim 8 wherein at least one of the stop members project into the space.

10. A hinge according to by any one of the claims 5 to 9 wherein first and second coupling portions are interchangeable.

11. A hinge according to any one of the clams 5 to 10 wherein each of the first and second coupling portions taper in a series of steps towards a respective outwardly facing end.

12. A hinge according to any one of the claims 5 to 11 wherein the first and second portions has a notch.

13. A hinge according to claim 12 wherein one of the first and second portions comprise a tooth arranged to be receivable by the notch.

14. A hinge according to any one of the claims 5 to 12 wherein the first and second portions are configured such that when brought together a cartridge is formed that houses the resilient member.

15. A hinge according to any one of the preceding claims wherein the first hinge part includes a first engagement surface and the first coupling portion includes a complementary shaped first engagement surface, the hinge being able to be configured so that the first engagement surfaces are engagable to prevent relative rotation between the first coupling portion and the first hinge part in at least one direction.

16. A hinge according to claim 15, wherein the second hinge part includes a second engagement surface and the first coupling portion includes a complementary shaped second engagement surface, the hinge being able to be configured so that either the first or the second engagement surfaces are engaged to prevent relative rotation of the first coupling portion and a respective one of the first and second hinge parts in at least one direction.

17. A hinge according to either claim 15 or 16, wherein the engagement surfaces are disengagable and are required to disengage to enable the first coupling portion to undergo the movement to change the biasing force of the biasing member.

18. A hinge according to claim 17, wherein the engagement surfaces are disengageble by moving the first coupling portion inwards along the axis.

19. A hinge according to claim 18, wherein the inward movement of the first coupling portion is resisted by the biasing member which biases the first coupling portion outwards along the axis.

20. A hinge according to any one of the preceding claims wherein the first and second hinge parts each have a respective leaf.

21. A hinge according to any one of the preceding claims wherein the first coupling portion engages the first hinge portion part in a first orientation and can be disengaged from the first hinge part and rotated to twist the biasing member and then brought back into engagement with the first hinge part in a second orientation.

22. A hinge according to any one of the preceding claims wherein the biasing member has a leg and the leg is disposed between two lugs projecting from the first coupling portion.

23. A hinge according to any one of the preceding claims wherein the hinge has a first configuration in which the stop arrangement is inoperable and a second configuration in which the stop assembly is operable.

24. A hinge according to claim 23 wherein the stop arrangement is operable when the first coupling portion is moved inward along the axis.

25. A hinge according to either claim 23 or 24 wherein the stop arrangement is inoperable when the first coupling portion engages with the first hinge part such that relative rotation between the first coupling portion and the first hinge part is prevented.

26. A coupling assembly for a hinge having an axis and opposite ends spaced along the axis, the coupling assembly comprising a biasing member, and first and second coupling portions disposed on the opposite ends of the biasing member, the coupling assembly being arranged to engage with first and second hinge parts and, when so engaged, the first and second hinge parts are rotatable relative to each other about the central axis and the biasing member is operative to impart a biasing force through the coupling portions to restrain relative rotation of the hinge parts.

27. A coupling assembly according to claim 26, wherein the biasing force of the biasing member can be varied by relative rotation of the coupling portions and the assembly further comprising a stop arrangement comprising first and second stop members disposed on respective ones of the first and second coupling portions, the stop members being operative to move into engagement under relative movement of the coupling portions and wherein, when so engaged, to prevent further relative movement of the coupling portions in at least one direction to thereby restrict change to the biasing force.

28. A coupling assembly according to claim 27 wherein the stop assembly has a first configuration in which the stop arrangement is inoperable and a second configuration wherein the stop arrangement is operable.

29. A coupling assembly according to claim 28 wherein in the second configuration the first and second portions are brought together.

30. A coupling assembly according to either one of claim 28 and claim 22 wherein in the first configuration the first and second portions are spaced apart.

31. A coupling assembly according to any one of the claims 26 to 30 arranged to be manipulated by a machine assembling the hinge.

32. A coupling assembly according to any one of the claims 26 to 31, wherein the first and second coupling portions define a space in which the biasing member is located.

33. A coupling assembly according to any one of claims 26 to 32, wherein the first coupling portion includes a first engagement surface arranged to be engagable with a complementary shaped first engagement surface in first hinge part to prevent relative rotation between the first coupling portion and the first hinge part in at least one direction.

34. A coupling assembly according to claim 33, wherein the first coupling portion further includes a second engagement surface arranged to be engagable with a complementary shaped second engagement surface in the second hinge part so that the coupling assembly can be arranged with either the first or the second engagement surfaces engaged to prevent relative rotation of the first coupling portion and a respective one of the first and second hinge parts in at least one direction.
